(19) United States
(12) Patent Application Publication
(10) Pub. No.: US 2024/0055708 A1
(43) Pub. Date: Feb. 15, 2024

(54) BATTERY ASSEMBLY

(71) Applicant: JOHANSSON OLSSON TECHNIQUE & DESIGN AB, Angered (SE)

(72) Inventors: Roger JOHANSSON, Öjesjön (SE); Erik PETTERSSON, Ödsmål (SE)

(73) Assignee: JOHANSSON OLSSON TECHNIQUE & DESIGN AB, Angered (SE)

(21) Appl. No.: 18/268,281

(22) PCT Filed: Dec. 22, 2020
(86) PCT No.: PCT/SE2020/051255

§ 371 Date: Jun. 19, 2023

(51) Int. Cl. H01M 50/202; H01M 50/264; H01M 50/213

(52) U.S. Cl. CPC H01M 50/202; H01M 50/264; H01M 50/213

(57) ABSTRACT

A battery assembly comprising a number of batteries in a holder with a first end surface directed to the same side of the battery assembly comprising both a plus pole and a minus pole. The battery assembly comprising an anode plate and a cathode plate covering the battery assembly on the same side as the anode plate with an electrically isolating layer between plates comprising through openings through the formed sandwich structure in connection to each battery and a minus connector connecting the minus pole of each battery to the anode plate and a plus connector connecting the plus pole of each battery to the cathode plate.

### TECHNICAL FIELD

The invention refers to a battery assembly comprising a holder for batteries and a number of batteries positioned next to each other in the holder, each battery extending in a longitudinal direction and a radial direction being perpendicular to the longitudinal direction, each battery having a first end surface and a second end surface opposite the first end surface delimiting the battery in the longitudinal direction, each battery comprising an envelope surface delimiting the batteries in the radial direction, the holder comprising one through channel per battery extending in the longitudinal direction housing the battery such that the first end surface is directed to the same side of the battery assembly, the first end surface comprising both a plus pole and a minus pole.

### BACKGROUND ART

It is well known in the art to pack batteries into a battery pack and it is also known to stack battery packs into a large battery assembly.

However, the ever-increasing utilisation of batteries in small as well as large applications, e.g. vehicles, there is a need for efficient batteries and battery stacks.

### SUMMARY OF INVENTION

The present invention solves a long felt need for a compact battery assembly.

The invention refers to a battery assembly comprising a holder for batteries and a number of batteries positioned next to each other in the holder, each battery extending in a longitudinal direction and a radial direction being perpendicular to the longitudinal direction. Each battery has a first end surface and a second end surface opposite the first end surface delimiting the battery in the longitudinal direction, and each battery comprises an envelope surface delimiting the batteries in the radial direction. The holder comprises one through channel per battery extending in the longitudinal direction housing the battery such that the first end surface is directed to the same side of the battery assembly, and the first end surface comprises both a plus pole and a minus pole. The battery assembly comprises an anode plate covering the battery assembly on the first end surface side of the battery assembly, and the battery assembly comprises a cathode plate covering the battery assembly on the same side as the anode plate. The battery assembly comprises an electrically isolating layer between the anode plate and the cathode plate, wherein the anode plate, the isolating layer and the cathode plate form a sandwich structure comprising through openings through the sandwich structure in connection to each battery. The battery assembly comprises a minus connector connecting the minus pole of each battery to the anode plate via at least the through opening of the anode plate, the battery assembly comprising a plus connector connecting the plus pole of each battery to the cathode plate via at least the through opening in the cathode plate.

One advantage with the battery assembly is that the anode and cathode plates are positioned on the same side of the battery assembly, which gives a compact battery assembly that is easy to assemble. The through openings in the anode and cathode plates allows for an easy connection from the plus pole and the minus pole to the respective anode and cathode plates, e.g. by use of a robot or the like.

According to one example, the anode plate is arranged closer to the batteries than the cathode plate, wherein the minus connector extend from the minus pole through the through opening of the anode plate, and wherein the plus connector extend from the plus pole through the through opening in the anode plate, the through opening in the isolating layer and the through opening in the cathode plate.

According to one example, the cathode plate is arranged closer to the batteries than the anode plate, wherein the plus connector extend from the plus pole through the through opening of the cathode plate, and wherein the minus connector extend from the minus pole through the through opening in the cathode plate, the through opening in the isolating layer and the through opening in the anode plate. Here, the battery assembly may comprise a further isolating layer or distance elements hindering the cathode plate from contacting the minus poles.

The order of stacking of the anode plate and the cathode plate is thus a design choice.

The isolating layer and/or the further isolating layer may be one continuous layer or may be I the form of pieces that builds distance.

The plus connector and/or the minus connector may be in the form of a wire-like connector attached to the respective plus and minus pole and the corresponding cathode and anode plates. The plus connector and/or the minus connector may be attached to the respective poles and plates with a bonding device comprising a bonding apparatus configured to operate in the through openings such that bonding of the plus connector and/or the minus connector can be performed. The bonding device can be any type of bonding device that allows for bonding a suitable plus connector and/or a minus connector. The plus connector and/or the minus connector can be part of the cathode plate and the anode plate respectively such that they extend from and through the through openings towards the plus and minus poles. Here, the plus connector and/or the minus connector has an extension from the respective cathode plate and anode plate to the plus pole and the minus pole in the first end surface. The plus connector and/or the minus connector may be arranged such that they connect to the respective plus and minus poles on the first end surface or such that they almost connect to the respective plus pole or minus pole as long as a welding or bonding tool can attach the plus connector and/or the minus connector to the respective plus pole and minus pole. The welding tool may be any type of welding tool suitable, for example laser welding or the like as long as the battery is no not damaged.

The through openings in the cathode plate, the anode plate and the isolation layer are formed so that the bonding or welding device can operate within the opening. The through openings in the anode plate and the cathode plate is further arranged such that trimming of electrical currents in the respective plate is possible. The shape of the through openings and the space between the openings are design parameters for electrical currents. It has been proven that a through opening with a drop like shape is beneficial. The through opening has advantageously a shape with a first curvature and a second curvature with two essentially straight lines connecting the first and the second curvatures. The first curvature can be described as a part circle having a first centre point with a radius describing the first curvature and the second curvature having a second centre point with a radius describing the second curvature. The first curvature has a radius less than the second curvature. The first centre point is positioned essentially aligned with the pole being centred in the battery and the second centre point is positioned essentially aligned with the pole being arranged in connection with the envelope surface. Here, it should be noted that the pole being centred can be the plus pole or the minus pole and the pole at the envelope surface can be the minus pole or the plus pole correspondingly. The through openings are advantageously arranged such that one line of through openings has a succession where the second curvature of one opening is followed by a first curvature of the next opening in succession and wherein an adjacent line of openings are arranged to the contrary, i.e. where the first curvature is succeeded by a second curvature if the next opening in succession. In this way the first curvature in one line is adjacent a second curvature in the adjacent line thereby forming a pattern diminishing a spread in distance between the openings in different lines.

The through openings are further arranged such that the plus pole is not in contact with the anode plate when the anode plate is arranged closest to the batteries. The anode plate may however be arranged to be in contact with the minus pole of the batteries and the minus connector strengthens the electrical connector. The anode plate here presses against the batteries for increased contact of the second end surface against the cooling plate. This is especially advantageous when the minus pole is arranged in connection to the envelope surface. Should the battery arrangement be arranged such that the cathode plate is closest to the batteries, then an isolation layer could be positioned between the minus pole and the cathode plate and/or the cathode plate could be configured such that is bears against the plus pole.

According to one example, each through channel comprises a recess extending from an edge of the through channel to at least a predetermined distance into the through channel, wherein the recess is configured to receive a fixing means securing the battery in the through channel. The fixing means can be any suitable fixing means that holds the batteries in place, for example an adhesive in the form of glue or the like and/or a welding material.

According to one example, the battery assembly comprises a cover plate configured to cover the anode plate, the isolation layer and the cathode plate. The cover plate is preferably made from an electrically non-conductive material that protects the electrically conductive anode and cathode plates.

According to one example, the battery assembly comprises a thermal element arranged on the opposite side of the battery assembly with respect to the anode plate, the isolation layer and the cathode plate for heating or cooling the batteries via the second end surfaces. The thermal element cools or heats the second end surface of each battery for optimum heat transfer. Here, the batteries are advantageously arranged such that they protrude out from the holder towards the thermal element for optimum contact between the second end plate and the cooling element.

According to one example, a battery stack comprises a number of holders connected to each other via attachment means. The attachment means may be a hooking arrangements or sliding arrangements that allows for one holder to be attached to another or any other suitable attachment means for example screws and bolts and nuts. The attachment means can be configured to attach the holders per se to each other and/or may be configured to attach one anode plate to another and/or one cathode plate to another.

According to one example, the cathode plate comprises a positive electrode and the anode plate comprises a negative electrode at the same side wall as the positive electrode, wherein the negative electrode is arranged distanced from and side by side with the positive electrode, wherein the positive electrode and the negative electrode from one battery assembly is connected in series or parallel to the positive electrode and the negative electrode of an adjacent battery assembly. According to one example, the positive electrode extends from the cathode plate and down along one side wall of the battery assembly and the negative electrode extends from the anode plate and down along the same side wall as the positive electrode such that the negative electrode on one holder contacts the positive electrode of the attached holder, and such that the positive electrode on one holder contacts the negative electrode of the attached holder, i.e. connected in series, or such that the negative electrode on one holder contacts the negative electrode of the attached holder and such that the positive electrode on one holder contacts the positive electrode of the attached holder, i.e. connected in parallel.

According to one example, a battery stack comprises a number of holders where the positive and negative electrode in one set of anode and cathode plates of one holder may be connected and attached via fastening means to the positive and negative electrode in another set of anode and cathode plates in an adjacent holder. The respective plates may be connected and attached to each other before assembly of the stack of holders. The fastening means may be any suitable fastening means, e.g. bolts and nuts and shrink bonding means.

According to one example, the positive electrode and the negative electrode can be used as a connector for voltage and/or current measurement, wherein a voltage and/or current measurement connector is connected to the positive electrode and the negative electrode by any suitable means, for example crimping arrangements, bolts and nuts etc. The connector for voltage and/or current measurement is connected to a sensor and/or measuring means configured to send information to control unit.

According to one example, the anode plate, the isolation layer and the cathode plate cover the batteries from at least two holders. Here, the positive electrode and the negative electrode are nor positioned between the holders, but are positioned on the side of the assembly according to the above for allowing attachment and electrical connection between a second assembly with separate anode and cathode plates.

According to one example, the thermal element is arranged to cover at least two holders. One advantage here is a simple and robust construction. Should the thermal element cover each holder, then the batteries in each holder can be cooled or heated independently.

According to one example, the thermal element is arranged between two battery assemblies. Here, the anode and cathode plates are positioned on each of the outsides of the assembly with a cover for each of the outsides. The thermal plate then cools or heats the batteries simultaneously on the second end surfaces of the batteries.

According to one example, the battery assembly comprises a temperature sensor configured to measure temperature of the battery assembly. The temperature sensor is advantageously positioned centrally in the battery assembly in order to measure the highest temperature in the assembly and/or may also be positioned at the edge of the battery assembly in order to measure the coolest point and possibly also the difference between the highest and coolest temperature. The holder may comprise a space in which the temperature is positioned.

According to one example, the battery assembly comprises a battery management system, BMS, configured to monitor the battery assembly. The BMS may comprise an analogue and/or digital control unit configured to control the battery assembly and thus the operation of the battery assembly. The analogue and/or digital control unit comprises means for receiving input from sensors and/or measuring means for controlling e.g. cooling of the batteries via the thermal element or heating the batteries via the thermal element and/or controlling electrical output of the battery assembly. The analogue and/or digital control unit may also comprise means for controlling charging of the battery.

The battery assembly is advantageously assembled by use of fastening means extending through the sandwich structure and at least part of the holder for holding the battery assembly together. The fastening means are advantageously bolts or screws that are connected to a suitable device allowing for tightening together the battery assembly in a direction coinciding with the longitudinal direction of the batteries. According to one example, the thermal element is part of the battery assembly and also fixed to the holder by fastening means. The fastening means can be attached to the holder and/or may be arranged through the holder. Fastening means can be arranged attaching the thermal element to the one side of the holder and fastening means can be arranged attaching the sandwich structure on the other side of the holder. As an alternative, the fastening means extend through the sandwich structure, the holder and the thermal element. As yet an alternative, the fastening means extend through the sandwich structure, the holder and partly through the thermal element, wherein the thermal element comprises a suitable devise for receiving and connecting to the fastening means. As an alternative, the fastening means extend through the thermal element, the holder and partly through the sandwich structure, wherein the sandwich structure comprises a suitable devise for receiving and connecting to the fastening means.

The battery assemblies according to the above can be arranged as a stack of battery assemblies in both width, length and height and the anode plate and/or cathode plate may cover one or more holders.

### BRIEF DESCRIPTION OF DRAWINGS

The invention will below be described in connection to a number of drawings, wherein;

FIG. 1 schematically shows an exploded view of a battery assembly;

FIG. 2 schematically shows a side view of a holder in the battery assembly;

FIG. 3 schematically shows a perspective view of a battery in the battery assembly;

FIG. 4 schematically shows a close up of a segment of FIG. 2;

FIG. 5 schematically shows a perspective view of a battery assembly seen from an anode and cathode side;

FIG. 6 schematically shows a perspective view of a battery assembly seen from an opposite side with relation to FIG. 5;

FIG. 7 schematically shows a top view of a holder in the battery assembly seen from an anode and cathode side;

FIG. 8 schematically shows a perspective view of a battery assembly comprising two holders;

FIG. 9 schematically shows a perspective view of a battery assembly comprising three holders;

FIG. 10 schematically shows a perspective view of a battery assembly comprising six holders;

FIG. 11 schematically shows a perspective view of a battery assembly comprising numerous holders;

FIG. 12 schematically shows a perspective view of a battery assembly comprising fastening means;

FIG. 13 schematically shows a perspective view of a cover plate for the battery assembly, and wherein;

FIG. 14 schematically shows a perspective view of a battery assembly seen from an anode and cathode side.

### DETAILED DESCRIPTION

The invention will below be described in connection to a number of non-exclusive embodiments. Like features will be denoted with like numbers. In order to facilitate the description of the embodiments a cylindrical coordinate system has been used describing the batteries 3 where the longitudinal direction is denoted Z-axis and the radial direction is denoted R-axis. It should be noted that even though cylindrical coordinates have been used, the batteries can be arranged in a cylindrical shape having a circular cross-section or the batteries can have a different cross-section, for example triangular, polynomial, oval or a combination of the geometries.

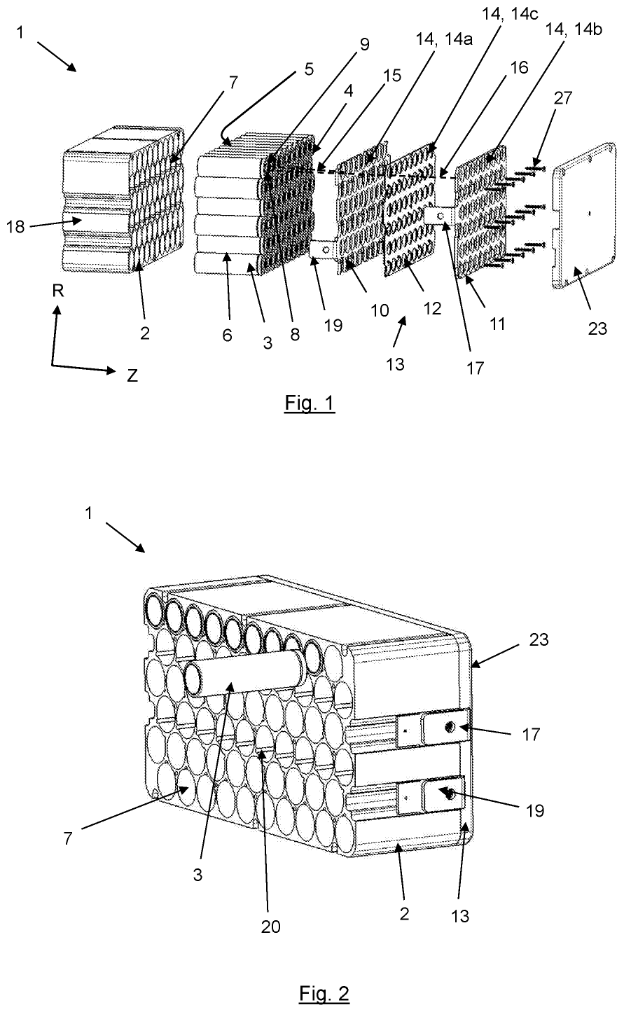

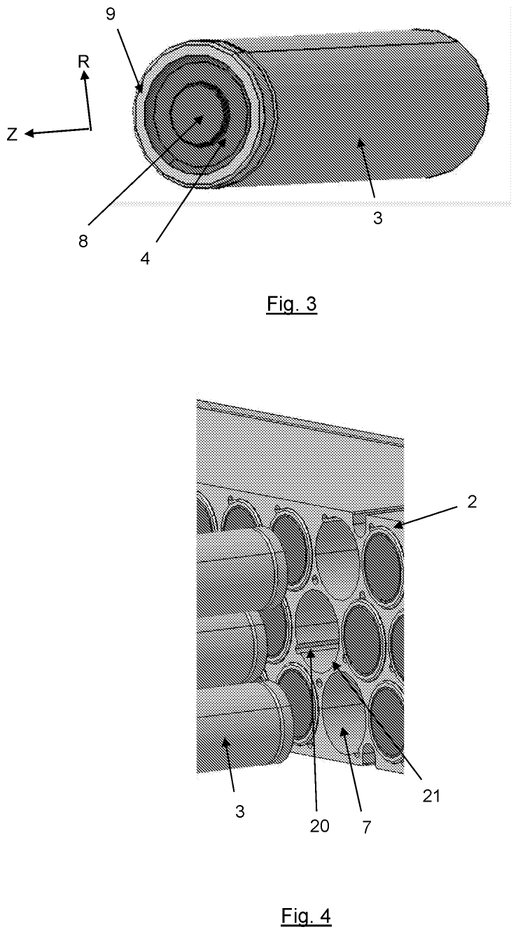

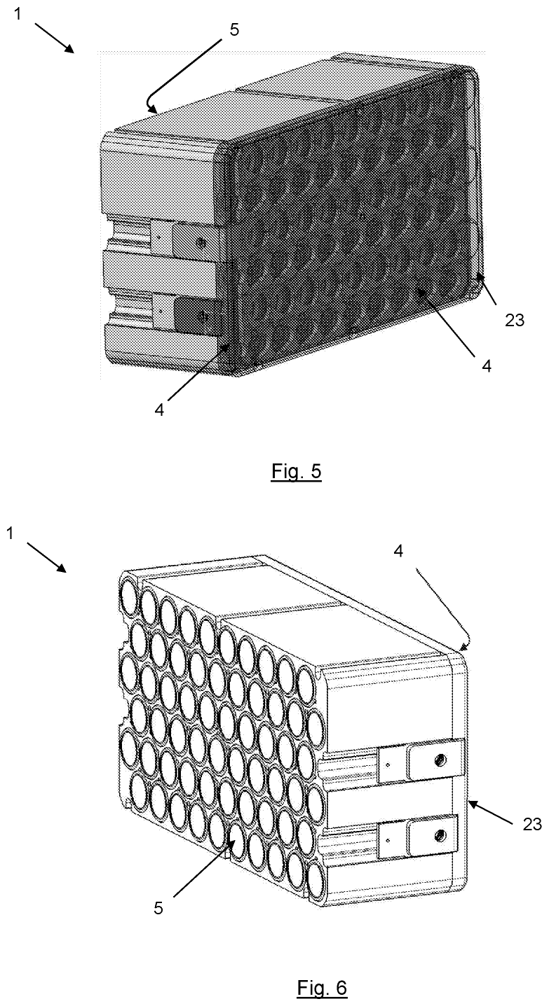

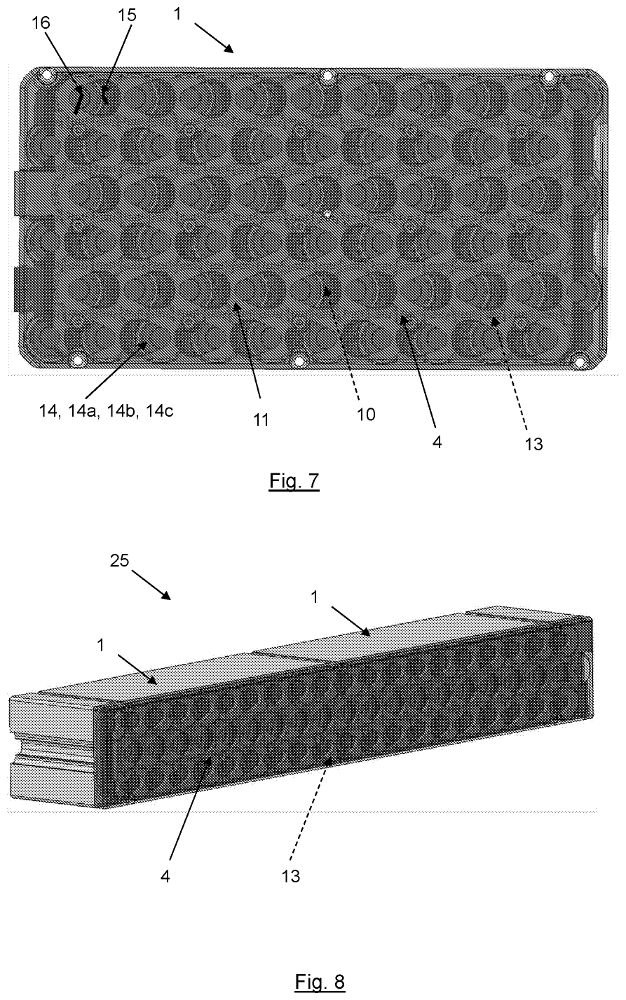

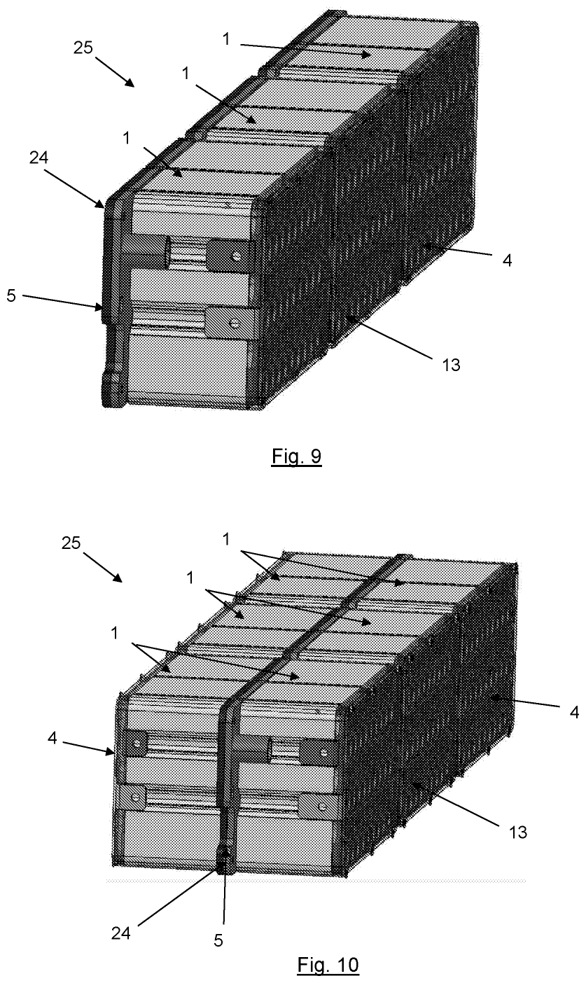

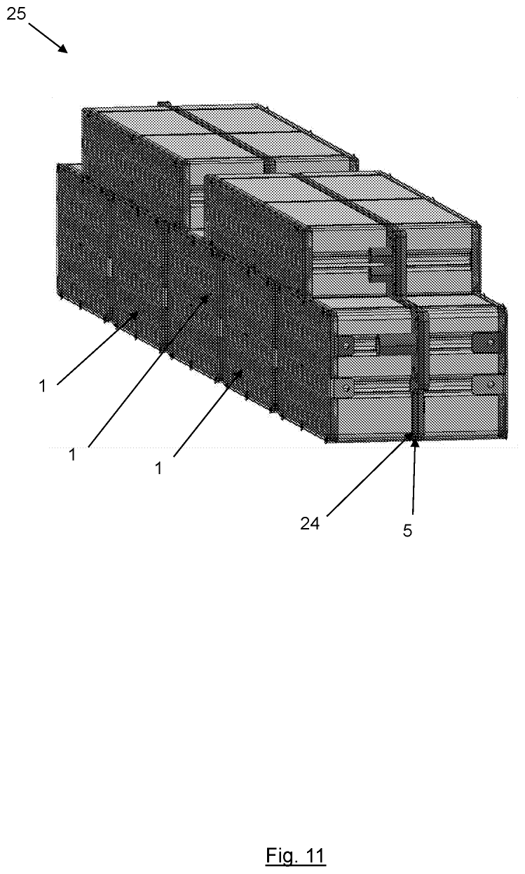

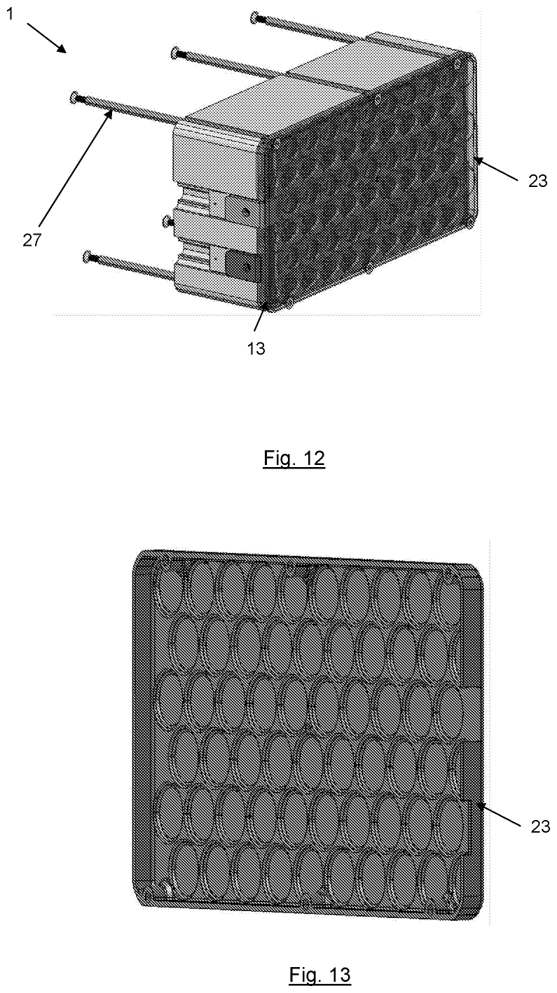

FIG. 1 schematically shows an exploded view of a battery assembly 1 according to the invention. FIG. 2 schematically shows a side view of a holder 2 in the battery assembly 1. FIG. 3 schematically shows a perspective view of a battery 3 in the battery assembly 1. FIG. 4 schematically shows a close up of a segment of FIG. 2. FIG. 5 schematically shows a perspective view of a battery assembly 1 seen from an anode plate 10 and cathode side 11 of the assembly 1. FIG. 6 schematically shows a perspective view of a battery assembly 1 seen from an opposite side with relation to FIG. 5. FIG. 7 schematically shows a top view of a holder 2 in the battery assembly 1 seen from an anode plate 10 and cathode plate 11 side. FIG. 8 schematically shows a perspective view of a battery assembly 1 comprising two holders 2. FIG. 9 schematically shows a perspective view of a battery assembly 1 comprising three holders 2. FIG. 10 schematically shows a perspective view of a battery assembly 1 comprising six holders 2. FIG. 11 schematically shows a perspective view of a battery assembly 2 comprising numerous holders 2. FIG. 12 schematically shows a perspective view of a battery assembly 1 comprising fastening means 27. FIG. 13 schematically shows a perspective view of a cover plate 23 for the battery assembly 1. In FIG. 12 the cover plate 23 is drawn transparent in order to show the underlying layers.

With reference to FIGS. 1-13, the invention refers to a battery assembly 1 comprising a holder 2 for batteries and a number of batteries 3 positioned next to each other in the holder 2, each battery 3 extending in a longitudinal direction Z and a radial direction R being perpendicular to the longitudinal direction Z, each battery 3 having a first end surface 4 and a second end surface 5 opposite the first end surface 4 delimiting the battery 3 in the longitudinal direction, each battery 3 comprising an envelope surface 6 delimiting the batteries 3 in the radial direction R, the holder 2 comprising one through channel 7 per battery 3 extending in the longitudinal direction Z housing the battery 3 such that the first end surface 4 is directed to the same side of the battery assembly 1, the first end surface 4 comprises both a plus pole 8 and a minus pole 9, the battery assembly 1 comprising an anode plate 10 covering the battery assembly 1 on the first end surface 4 side of the battery assembly 1, the battery assembly 1 comprising a cathode plate 11 covering the battery assembly 1 on the same side as the anode plate 10, the battery assembly 1 comprising an electrically isolating layer 12 between the anode plate 10 and the cathode plate 11, wherein the anode plate 10, the isolating layer 12 and the cathode plate 11 form a sandwich structure 13 comprising through openings 14 through the sandwich structure 13 in connection to each battery 3, the battery assembly 1 comprising a minus connector 15 connecting the minus pole 9 of each battery 3 to the anode plate 10 via at least the through opening 14a of the anode plate 10, the battery assembly 1 comprising a plus connector 16 connecting the plus pole 8 of each battery 3 to the cathode plate 11 via at least the through opening 11b in the cathode plate 11.

According to one example, see FIG. 1, the anode plate 10 is arranged closer to the batteries 3 than the cathode plate 11, wherein the minus connector 15 extend from the minus pole 9 through the through opening 14a of the anode plate 10, and wherein the plus connector 16 extend from the plus pole 8 through the through opening 14a in the anode plate 10, the through opening 14c in the isolating layer 12 and the through opening 14b in the cathode plate 11.

According to one example, not shown, the cathode plate 11 is arranged closer to the batteries 3 than the anode plate 10, wherein the plus connector 16 extend from the plus pole 8 through the through opening 14b of the cathode plate 11, and wherein the minus connector 15 extend from the minus pole 9 through the through opening 14b in the cathode plate 11, the through opening 14c in the isolating layer 12 and the through opening 14a in the anode plate 10.

According to one example, the cathode plate 11 comprises a positive electrode 17 extending from the cathode plate 11 and down along one side wall 18 of the battery assembly 1, wherein the anode plate comprises a negative electrode 19 extending from the anode plate 10 and down along the same side wall 18 as the positive electrode 17, wherein the negative electrode 19 is arranged distanced from and side by side with the positive electrode 17.

According to one example, each through channel 7 comprises a recess 20 extending from an edge 21 of the through channel 7 to at least a predetermined distance into the through channel, wherein the recess 20 is configured to receive a fixing means 22 securing the battery 3 in the through channel 7.

It should be noted that the through channel 7 has a similar geometrical cross-section as the battery for a snug fit.

According to one example, the battery assembly 1 comprises a cover plate 23 configured to cover the anode plate 10, the isolation layer 12 and the cathode plate 11.

According to one example, the battery assembly 1 comprises a thermal element 24 arranged on the opposite side of the battery assembly 1 with respect to the anode plate 10, the isolation layer 12 and the cathode plate 11 for heating or cooling the batteries 3 via the second end surfaces 5. According to one example, the thermal element 24 is arranged to cover at least two holders 2. According to one example, the thermal element 24 is arranged between two battery assemblies 1, see for example FIG. 10.

The invention also refers to a battery stack 25 comprising a number of battery assemblies 1 according to the above, wherein the battery stack 25 comprises a number of holders 2 connected to each other via attachment means 26, see for example FIGS. 8-11.

According to one example, the anode plate 10, the isolation layer 12 and the cathode plate 11 cover the batteries 3 from at least two holders 2, see for example FIG. 8.

The plus connector 16 and/or the minus connector 15 may be in the form of a wire like connector attached to the respective plus and minus pole 8, 9 and the corresponding cathode and anode plates 11, 10, as seen in e.g. FIGS. 1 and 7. The plus connector 16 and/or the minus connector 15 may be attached to the respective poles and plates with a bonding device comprising a bonding apparatus configured to operate in the through openings such that bonding of the plus connector and/or the minus connector can be performed. The bonding device can be any type of bonding device that allows for bonding a suitable plus connector and/or a minus connector. In FIG. 1, the plus connector 16 and the minus connector 15 are shown with a dotted line and only from one battery for eligibility, but it should be noted that a plus connector 16 and a minus connector 15 are attached to each of the batteries in the battery assembly. Also in FIG. 7 the plus connector 16 and the minus connector 15 are shown only from one battery for eligibility, but it should be noted that a plus connector 16 and a minus connector 15 are attached to each of the batteries in the battery assembly accordingly.

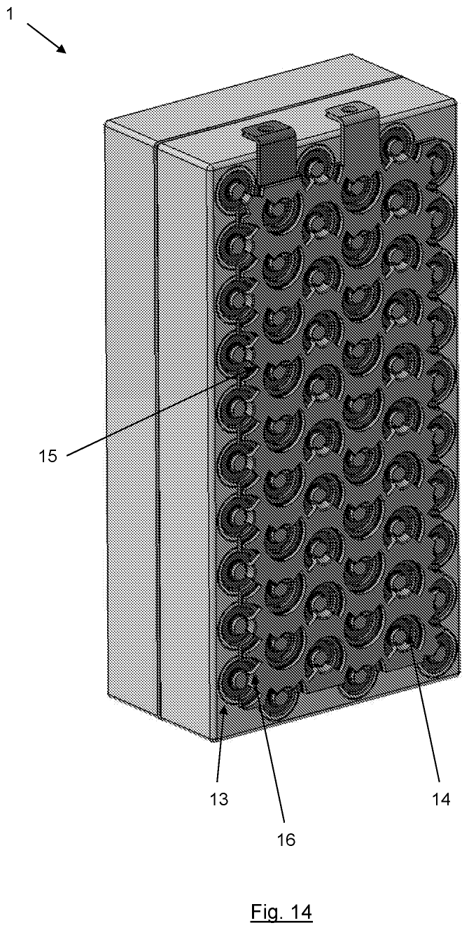

FIG. 14 schematically shows a perspective view of a battery assembly seen from an anode and cathode side. In FIG. 14, the plus connector 16 and/or the minus connector 15 can be part of the cathode plate 11 and the anode plate 10 respectively such that they extend from and through the through openings towards the plus and minus poles. Here, the plus connector 16 and/or the minus connector 15 has an extension from the respective cathode plate 11 and anode plate 10 to the plus pole 8 and the minus pole 9 in the first end surface 4. The plus connector 16 and/or the minus connector 15 may be arranged such that they connect to the respective plus and minus poles on the first end surface or such that they almost connect to the respective plus pole or minus pole as long as a welding or bonding tool can attach the plus connector and/or the minus connector to the respective plus pole and minus pole. The welding tool may be any type of welding tool suitable, for example laser welding or the like as long as the battery is no not damaged.

According to one example (not shown) the battery stack 25 is configured such that the cathode plate 11 comprises a positive electrode 17, wherein the anode plate 10 comprises a negative electrode 19 at the same side wall 18 as the positive electrode 17, wherein the negative electrode 19 is arranged distanced from and side by side with the positive electrode 17, wherein the positive electrode 17 and the negative electrode 19 from one battery assembly 1 is connected in series or parallel to the positive electrode 17 and the negative electrode 19 of an adjacent battery assembly 1. The positive electrode 17 and the negative electrode 19 can be arranged extending down along the side as described above and shown in e.g. FIG. 1, or may be arranged as connection points suitable for connecting to an adjacent battery assembly 1 with corresponding connection points. The positive electrode 17 and the negative electrode 19 can be directly connected to each other or can be connected to each other via an intermediate conductor attached to the respective positive electrode 17 and negative electrode 19 depending on type of connection, i.e. in series or parallel. Here it should be noted that connecting batteries in series gives a higher voltage output and connecting batteries in parallel gives a higher current is known per se.

1. A battery assembly comprising a holder for batteries and a number of batteries positioned next to each other in the holder, each battery extending in a longitudinal direction (Z) and a radial direction (R) being perpendicular to the longitudinal direction (Z), each battery having a first end surface and a second end surface opposite the first end surface delimiting the battery in the longitudinal direction, each battery comprising an envelope surface delimiting the batteries in the radial direction (R), the holder comprising one through channel per battery extending in the longitudinal direction (Z) housing the battery such that the first end surface is directed to the same side of the battery assembly, the first end surface comprises both a plus pole and a minus pole, the battery assembly comprising an anode plate covering the battery assembly on the first end surface side of the battery assembly, the battery assembly comprising a cathode plate covering the battery assembly on the same side as the anode plate, the battery assembly comprising an electrically isolating layer between the anode plate and the cathode plate, wherein the anode plate, the isolating layer and the cathode plate form a sandwich structure comprising through openings through the sandwich structure in connection to each battery, the battery assembly comprising a minus connector connecting the minus pole of each battery to the anode plate via at least the through opening of the anode plate, the battery assembly comprising a plus connector connecting the plus pole of each battery to the cathode plate via at least the through opening in the cathode plate.

2. A battery assembly according to claim 1, wherein the anode plate is arranged closer to the batteries than the cathode plate, wherein the minus connector extends from the minus pole through the through opening of the anode plate, and wherein the plus connector extends from the plus pole through the through opening in the anode plate the through opening in the isolating layer and in the through opening the cathode plate.

3. A battery assembly according to claim 1, wherein the cathode plate is arranged closer to the batteries than the anode plate, wherein the plus connector extends from the plus pole through the through opening of the cathode plate, and wherein the minus connector extends from the minus pole through the through opening in the cathode plate, the through opening in the isolating layer and the through opening in the anode plate.

4. A battery assembly (1) according to claim 1, wherein each through channel comprises a recess extending from an edge of the through channel to at least a predetermined distance into the through channel, wherein the recess is configured to receive a fixing means securing the battery in the through channel.

5. A battery assembly according to claim 1, wherein the battery assembly comprises a cover plate configured to cover the anode plate, the isolation layer and the cathode plate.

6. A battery assembly according to claim 1, wherein the battery assembly comprises a thermal element arranged on the opposite side of the battery assembly with respect to the anode plate, the isolation layer and the cathode plate for heating or cooling the batteries via the second end surfaces.

7. A battery stack comprising a number of battery assemblies as claimed in claim 1, wherein the battery stack comprises a number of holders connected to each other via an attachment.

8. The battery stack according to claim 7, wherein the anode plate, the isolation layer and the cathode plate cover the batteries from at least two holders.

9. The battery stack according to claim 6, wherein the thermal element is arranged to cover at least two holders.

10. The battery stack according to claim 6, wherein the thermal element is arranged between two battery assemblies.

11. The battery stack according to claim 1, wherein the cathode plate comprises a positive electrode, wherein the anode plate comprises a negative electrode at the same side wall as the positive electrode, wherein the negative electrode is distanced from and side by side with the positive electrode, wherein the positive electrode and the negative electrode from one battery assembly is connected in series or parallel to the positive electrode and the negative electrode of an adjacent battery assembly.

12. A battery assembly according to claim 1, wherein the positive electrode extends from the cathode plate and down along one side wall of the battery assembly, wherein the negative electrode extends from the anode plate and down along the same side wall as the positive electrode, wherein the negative electrode is distanced from and side by side with the positive electrode.
